(19) United States
(12) Patent Application Publication
(10) Pub. No.: US 2021/0217365 A1
(43) Pub. Date: Jul. 15, 2021

(54) PIXEL UNIT CIRCUIT, DRIVING METHOD THEREOF, PIXEL CIRCUIT AND DISPLAY DEVICE

(71) Applicant: BOE TECHNOLOGY GROUP CO., LTD., Beijing (CN)

(72) Inventors: Minghua XUAN, Beijing (CN); Shengji YANG, Beijing (CN); Xiaochuan CHEN, Beijing (CN)

(73) Assignee: BOE TECHNOLOGY GROUP CO., LTD., Beijing (CN)

(21) Appl. No.: 16/078,372

(22) PCT Filed: Jan. 29, 2018
(86) PCT No.: PCT/CN2018/074426

§ 371 Date: Aug. 21, 2018

(30) Foreign Application Priority Data
Jul. 12, 2017 (CN) 201710564519.6

(51) Int. Cl. G09G 3/3266

(52) U.S. Cl. CPC G09G 3/3266; G09G 2300/0842; G09G 2310/06; G09G 2300/0866; G09G 2300/0469

(57) ABSTRACT

The pixel unit circuit includes a first control module, a storage capacitor module, a second control module, and a light emitting element. First, second, and third ends of the first control module are connected to a row gate line, a column gate line, and a first node, the first control module controls whether the first node are connected to the column gate; the second end of the storage capacitor module is connected to a high level input end; second, third, fourth ends of the second control module are connected to a first end of the light emitting element, a high level input end, and a low level input end, the second control module controls the first end of the light emitting element to be electrically connected to the high or low level input end.

### CROSS-REFERENCE TO RELATED APPLICATION

The present application claims a priority of the Chinese patent application No. 201710564519.6 filed on Jul. 12, 2017, which is incorporated herein by reference in its entirety.

### TECHNICAL FIELD

The present disclosure relates to the field of display technology, and specifically relates to a pixel unit circuit, a method for driving the same, a pixel circuit and a display device.

### BACKGROUND

The brightness of a silicon-based OLED (Organic Light-Emitting Diode) is usually controlled by driving a current in the subthreshold region of a MOS transistor (Metal-Oxide-Semiconductor-Field Effect Transistor). Since the current of the MOS transistor is proportional to its W/L (width to length ratio), in order to realize a small current of the micro display pixel, it is necessary to design the W/L ratio of the driving MOS transistor to be small, such as length L of the driving MOS transistor being designed very large. In this way, it is difficult to apply the silicon-based OLED to a high-resolution display product, the storage capacitor cannot be made large, and the data voltage cannot be stably maintained, thereby causing the brightness of the OLED to be unstable. Moreover, the subthreshold current of the MOS transistor is sensitive to the gate-source voltage and the threshold voltage, and the peripheral circuit is complicated. Therefore, for some circuit/electronic components (such as conventional silicon-based pixel circuits) that use the driving MOS transistors operated at the subthreshold, it is difficult to reduce the area of the driving MOS transistor, which makes it difficult to be applied to ultra-high resolution products. The driving current of the OLED is sensitive to the gate-source voltage and the threshold voltage of the driving MOS transistor, and the peripheral circuit is relatively complicated.

### SUMMARY

In order to achieve the above object, a pixel unit circuit, a method for driving the same, a pixel circuit and a display device are provided.

In one aspect, a pixel unit circuit includes a first control module, a storage capacitor module, a second control module, and a light emitting element, wherein a first end, a second end, and a third end of the first control module are respectively connected to a row gate line, a column gate line, and a first end of the storage capacitor module and a first end of the second control module, the first control module is configured to control whether the first end of the second control module and the first end of the storage capacitor module are electrically connected to the column gate line under the control of the row gate line; the second end of the storage capacitor module is connected to a high level input end; a second end, a third end, and a fourth end of the second control module are respectively connected to a first end of the light emitting element, a high level input end, and a low level input end, the second control module is configured to control the first end of the light emitting element to be electrically connected to the high level input or the low level input end by a potential of the first end of the second control module.

In some embodiment of the present disclosure, the second node control module includes a first PMOS transistor, a gate electrode of the first PMOS transistor connected to a third end of the first control module and a first end of the storage capacitor module, a first electrode of the first PMOS transistor connected to the high level input end, and a second electrode of the first PMOS transistor connected to a first end of the light emitting element; and a first NMOS transistor, a gate electrode of the first NMOS transistor connected to the third end of the first control module and the first end of the storage capacitor module, a first electrode of the first NMOS transistor connected to the low level input end, and a second electrode of the first NMOS transistor connected to the first end of the light emitting element.

In some embodiment of the present disclosure, the second node control module includes a first NMOS transistor, a gate electrode of the first NMOS transistor connected to a third end of the first control module and a first end of the storage capacitor module, a first electrode of the first NMOS transistor connected to a first end of the light emitting element, and a second electrode of the first NMOS transistor connected to a high level input end; and a first PMOS transistor, a gate electrode of the first PMOS transistor connected to the third end of the first control module and the first end of the storage capacitor module, a first electrode of the first PMOS transistor connected to the first end of the light emitting element, and a second electrode of the first PMOS transistor connected to the low-level input end.

In some embodiment of the present disclosure, the first node control module comprises: a second NMOS transistor, a gate electrode of the second NMOS transistor connected to the row gate line, a first electrode of the second NMOS transistor connected to the gate electrode of the first PMOS transistor, the gate electrode of the first NMOS transistor, and the first end of the storage capacitor module, and a second electrode of the second NMOS transistor connected to the column gate line.

In some embodiment of the present disclosure, the first node control module comprises: a second PMOS transistor, a gate electrode of the second PMOS transistor connected to the row gate line, a first electrode of the second PMOS transistor connected to the column gate line, and a second electrode of the second PMOS transistor connected to the gate electrode of the first PMOS transistor, the gate electrode of the first NMOS transistor, and the first end of the storage capacitor module.

In some embodiment of the present disclosure, the first node control module is configured to: control brightness of the light emitting element based on a ratio of turning-on time period and turning-off time period of the first PMOS transistor within a display frame; or control brightness of the light emitting element based on a ratio of turning-on time period and turning-off time period of the first NMOS transistor within a display frame.

In some embodiment of the present disclosure, the storage capacitor module comprises: a storage capacitor, the first end of the storage capacitor connected to the third end of the first control module and the first end of the second control module, and the second end of the storage capacitor connected to the high level input end.

In some embodiment of the present disclosure, the second end of the light emitting element is connected to the low level input end, the light emitting element includes an organic light emitting diode, the first end of the light emitting element is an anode of the organic light emitting diode, and the second end of the light emitting element is a cathode of the organic light emitting diode.

In some embodiment of the present disclosure, the second end of the light emitting element is connected to the high level input end, the light emitting element comprises an organic light emitting diode, the first end of the light emitting element is a cathode of the organic light emitting diode, and the second end of the light emitting element is an anode of the organic light emitting diode.

In another aspect, a method for driving a pixel unit circuit is provided. The method includes controlling, the first control module, whether the first end of the storage capacitor module and the first end of the second control module being electrically connected to the column gate line under the control of the row gate line; controlling, the second control module, the first end of the light emitting element to be connected to the high level input end or the low level input end under the control of the first node, so that the light emitting element emits light or does not emit light.

In some embodiment of the present disclosure, the first node control module includes the second NMOS transistor having a gate electrode connected to the row gate line, a first electrode connected to the first end of the second control module and the first end of the storage capacitor module, and a second electrode connected to the column gate line, the step of controlling, by the first node control module, whether the first node is connected to the column gate line under the control of the row gate line includes: when the row gate line outputs a high level signal, the second NMOS transistor being turned on, thereby controlling the first end of the second control module and the first end of the storage capacitor module to be connected to the column gate line; and when the row gate line outputs a low level signal, the second NMOS transistor being turned off, thereby controlling the first end of the second control module and the first end of the storage capacitor module not to be connected to the column gate line.

In some embodiment of the present disclosure, the first node control module includes the second PMOS transistor having a gate electrode connected to the row gate line, a first electrode connected to the column gate line, and a second electrode connected to the first end of the second control module and the first end of the storage capacitor module, the step of controlling, by the first node control module, whether the first end of the second control module and the first end of the storage capacitor module are connected to the column gate line under the control of the row gate line includes: when the row gate line outputs a low level signal, the second PMOS transistor being turned on, thereby controlling the first end of the second control module and the first end of the storage capacitor module to be connected to the column gate line; and when the row gate line outputs a high level signal, the second PMOS transistor being turned off, thereby controlling the first end of the second control module and the first end of the storage capacitor module not to be connected to the column gate line.

In some embodiment of the present disclosure, when the second node control module includes a first PMOS transistor having a gate electrode connected to the third end of the first control module and the first end of the storage capacitor module, a first electrode connected to the high level input end, and a second electrode connected to the first end of the light emitting element; and a first NMOS transistor having a gate electrode connected to the third end of the first control module and the first end of the storage capacitor module, the first electrode connected to the low-level input end, and the second electrode connected to the first end of the light emitting element, the step of controlling, by the second node control module, the first end of the light emitting element to be connected to the high level input end or the low level input end, includes: when the potential of the first end of the second control module is at a high level, the first PMOS transistor being turned off and the first NMOS transistor being turned on, to control the first end of the light emitting element to be connected to the low level input; when the potential of the first end of the second control module is at a low level, the first PMOS transistor being turned on and the first NMOS transistor being turned off, to control the first end of the light emitting element to be connected to the high level input end.

In some embodiment of the present disclosure, the second node control module includes a first NMOS transistor having a gate electrode connected to the third end of the first control module and the first end of the storage capacitor module, a first electrode connected to the first end of the light emitting element, and a second electrode connected to the high level input end, and; and a first PMOS transistor having a gate electrode connected to the third end of the first control module and the first end of the storage capacitor module, the first electrode connected to the first end of the light emitting element, and the second electrode connected to the low-level input end, the step of controlling, by the second node control module, the first end of the light emitting element to be connected to the high level input end or the low level input end, includes: when the potential of the first end of the second control module is at a low level, the first PMOS transistor being turned on and the first NMOS transistor being turned off, to control the first end of the light emitting element to be connected to the low level input; when the potential of the first end of the second control module is at a high level, the first PMOS transistor being turned off and the first NMOS transistor being turned on, to control the first end of the light emitting element to be connected to the high level input end.

In some embodiment of the present disclosure, the method further includes: controlling, by the first control module, brightness of the light emitting element based on a ratio of turning-on time period and turning-off time period of the first PMOS transistor within a display frame; or controlling, by the first control module, brightness of the light emitting element based on a ratio of turning-on time period and turning-off time period of the first NMOS transistor within a display frame.

In some embodiment of the present disclosure, the second end of the light emitting element is connected to the low level input end, the light emitting element comprises an organic light emitting diode, the first end of the light emitting element is an anode of the organic light emitting diode, and the second end of the light emitting element is a cathode of the organic light emitting diode, when the first end of the light emitting element is connected to the low level input end, the light emitting element does not emit light, and when the first end of the light emitting element is connected to the high level input end, the light emitting element emits light.

In some embodiment of the present disclosure, the second end of the light emitting element is connected to the high level input end, the light emitting element comprises an organic light emitting diode, the first end of the light emitting element is a cathode of the organic light emitting diode, and the second end of the light emitting element is an anode of the organic light emitting diode, when the first end of the light emitting element is connected to the low level input end, the light emitting element emits light, and when the first end of the light emitting element is connected to the high level input end, the light emitting element does not emit light.

In yet another aspect, a pixel circuit disposed on a silicon substrate includes a plurality of row gate lines, a plurality of column gate lines, and a plurality of pixel unit circuits arranged in an array, wherein the pixel unit circuits located in a same row are connected to a same row gate line; the pixel unit circuits located in a same column are connected to a same column gate line.

In yet another aspect, a display device includes a silicon substrate, and a plurality of row gate lines and a plurality of column gate lines disposed on the silicon substrate, and a plurality of pixel unit circuits arranged in an array, wherein the pixel unit circuits located in a same row are connected to a same row gate line. The pixel unit circuits located in a same column are connected to a same column gate line.

### BRIEF DESCRIPTION OF THE DRAWINGS

FIG. 1 is a structural diagram of a pixel unit circuit of some embodiments of the present disclosure;

FIG. 2 is a structural diagram of a pixel unit circuit of some embodiments of the present disclosure;

FIG. 3 is a structural diagram of a pixel unit circuit of some embodiments of the present disclosure;

FIG. 4 is a circuit diagram of a pixel unit circuit of some embodiments of the present disclosure;

FIG. 5 is an exemplary operation timing diagram of the pixel unit circuit shown in FIG. 4;

FIG. 6 is another exemplary operation timing diagram of the pixel unit circuit shown in FIG. 4;

FIG. 7 is still another exemplary operation timing diagram of the pixel unit circuit shown in FIG. 4.

### DETAILED DESCRIPTION OF THE EMBODIMENTS

The technical solutions of the present disclosure are clearly and completely described below in conjunction with the accompanying drawings. Obviously, the embodiments are only a part of embodiments, but not all embodiments. All other embodiments obtained by a person skilled in the art without creative work are all within the scope of the disclosure.

In some embodiments, a pixel unit circuit is provided, including: a first control module, a storage capacitor module, a second control module, and a light emitting element. A first end, a second end, and a third end of the first control module are respectively connected to a row gate line, a column gate line, and a first end of the storage capacitor module and a first end of the second control module. The first control module is configured to control whether the first end of the second control module and the first end of the storage capacitor module are electrically connected to the column gate line under the control of the row gate line. The second end of the storage capacitor module is connected to a high level input end. A second end, a third end, and a fourth end of the second control module are respectively connected to a first end of the light emitting element, a high level input end, and a low level input end. The second control module is configured to control the first end of the light emitting element to be electrically connected to the high level input or the low level input by a potential of the first end of the second control module.

Optionally, the light emitting element comprises an organic light emitting diode.

Optionally, the second end of the light emitting element can be connected to the low level input. Specifically, the first end of the light emitting element is an anode of the organic light emitting diode, and the second end of the light emitting element is a cathode of the organic light emitting diode.

Optionally, the second end of the light emitting element can be connected to the high level input. Specifically, the first end of the light emitting element is a cathode of the organic light emitting diode, and the second end of the light emitting element is an anode of the organic light emitting diode.

For convenience of description and understanding, in the following embodiments, a connection point of the third end of the first control module, the first end of the storage capacitor module, and the first end of the second control module is referred to as a first node; a connection point between the first end of the light emitting element and the second end of the second control module is referred to as a second node. The first control module is referred to as a first node control module, and the second control module is referred as a second node control module.

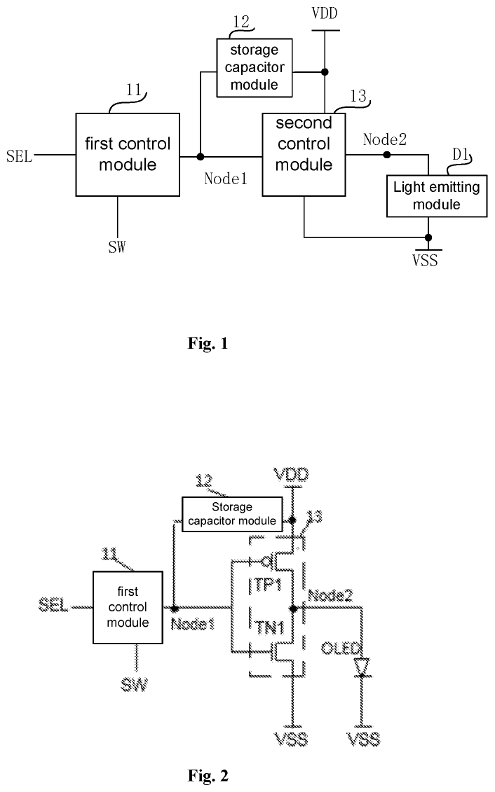

As shown in FIG. 1, the pixel unit circuit of the embodiment of the present disclosure includes: a first node control module 11, respectively connected to a row gate line SW, a column gate line SEL and a first node Node1, configured to control whether the first node Node1 being connected to the column gate line SEL under the control of the row gate line SW; a storage capacitor module 12, a first end thereof connected to the first node Node1 and a second end thereof connected to a high level input end inputting a high level VDD; a second node control module 13, respectively connected to the first node Node1, the second node Node2, the high level input end inputting the high level VDD, and a low level input end inputting a low level VSS, configured to control the second node Node2 to be connected to a high level input end inputting the high level VDD or the low level input end inputting the low level VSS under the control of the first node Node1; and a light-emitting element D1, a first end thereof connected to the second node Node2 and a second end thereof connected to the low-level input end inputting the low level VSS.

In actual operation, the light emitting element D1 may include an organic light emitting diode; a first end of the light emitting element D1 is an anode of the organic light emitting diode, and a second end of the light emitting element D1 is the cathode of the organic light emitting diode.

The pixel unit circuit of the embodiment of the present disclosure to controls the display brightness of the light-emitting element D1 by a turn-on time period of a PMOS transistor (Positive Channel Metal Oxide Semiconductor) included in the second node control module 13 and a turn-on time period of an NMOS transistor (Negative channel Metal Oxide Semiconductor) included in the second node control module 13. The pixel unit circuit according to the embodiment of the present disclosure controls a potential of the first node Node1 through the first node control module 11, and controls the PMOS transistor or the NMOS transistor included in the second node control module 13 to be turned on by the potential of the first node Node1, thereby controlling the second node Node2 to receive the high level VDD to make the light emitting element D1 emit light, or controlling the second node Node2 to receive the low level VSS to make the light emitting element D1 not emit light.

Certainly, the second end of the light-emitting element D1 may also be connected to the high-level input end inputting the high level VDD, and the PMOS transistor or the NMOS transistor included in the second node control module 13 may be controlled to be turned on by the potential of the first node Node1, thereby controlling the second node Node2 to receive the high level VDD such that the light emitting element D1 does not emit light, or controlling the second node Node2 to receive the low level VSS so that the light emitting element D1 emits light. It should be understood that embodiments of the present disclosure, the second end of the light emitting element being connected to the high level or low level input is not limited.

In the technical solution of the pixel unit circuit described in the embodiment of the present disclosure, the NMOS transistor and the PMOS transistor included in the second node control module 13 are operated in a saturation region or turned off, so the dimension L (length) of the transistor is not required to be designed too large, so that the pixel unit circuit described in the embodiment of the present disclosure can be applied to a high resolution display product. Moreover, the NMOS transistor and the PMOS transistor included in the second node control module 13 only function as a switch, and the brightness is controlled by the ratio of the turning on time period and the turning off time period of the NMOS transistor and the PMOS transistor. Within one frame of display time, the operating time period of the organic light emitting diode OLED is the light emitting time period of the light emitting element D1, and the operating time period and average current of the light emitting element D1 can be reduced.

According to a specific implementation, the second node control module may include: a first PMOS transistor, a gate electrode thereof connected to the first node, a first electrode thereof connected to the high level input end, and a second electrode thereof connected to the second node; and a first NMOS transistor, a gate electrode thereof connected to the first node, a first electrode thereof connected to the low level input end, and a second electrode thereof connected to the second node.

As shown in FIG. 2, on the basis of the embodiment of the pixel unit circuit shown in FIG. 1, the light emitting element includes an organic light emitting diode OLED, and an anode of the organic light emitting diode OLED is connected to the second node Node2. The cathode of the organic light emitting diode OLED is connected to the low level input end inputting the low level VSS. The second node control module 13 includes: a first PMOS transistor TP1, a gate electrode thereof connected to the first node Node1, a source electrode thereof connected to the high level input end inputting the high level VDD, and a drain electrode thereof connected to the second node Node2; and a first NMOS transistor TN1, a gate electrode thereof connected to the first node Node1, a source electrode thereof connected to the low level input inputting the low level VSS, and a drain electrode thereof connected to the second node Node2.

In actual operation, when the potential of the first node Node1 is a low level, TP1 is turned on, TN1 is turned off, a potential of the second node Node2 is at a high level VDD. When the potential of the first node Node1 is at a high level, TP1 is turned off, TN2 is turned on, and the potential of the second node Node2 is at a low level VSS.

According to another specific implementation, the second node control module may include: a first NMOS transistor, a gate electrode thereof connected to the first node, a first electrode thereof connected to the second node, and a second electrode thereof connected to the high level input end; and a first PMOS transistor, a gate electrode thereof connected to the first node, a first electrode thereof connected to the second node, and a second electrode thereof connected to the low level input end.

As shown in FIG. 3, on the basis of the embodiment of the pixel unit circuit shown in FIG. 1, the light emitting element includes an organic light emitting diode OLED. The anode of the organic light emitting diode OLED is connected to the second node Node2. The cathode of the organic light emitting diode OLED is connected to a low level input end inputting the low level VSS.

The second node control module 13 includes: a first NMOS transistor TN1, a gate electrode thereof connected to the first node Node1, a drain electrode thereof connected to a high level input end inputting the high level VDD, and a source electrode thereof connected to the second node Node2; a first PMOS transistor TP1, a gate electrode thereof connected to the first node Node1, a drain electrode thereof connected to the low-level input end inputting the low level VSS, and a source electrode thereof connected to the second node Node2.

In actual operation, when the potential of the first node Node1 is at a low level, TP1 is turned on, TN1 is turned off, the potential of the second node Node2 is at the low level VSS; when the potential of the first node Node1 is at a high level, TP1 is turned off, TN2 is turned on, and the potential of the second node Node2 is at a high level VDD.

Specifically, the first node control module may include: a second NMOS transistor, a gate electrode thereof connected to the row gate line, a first electrode thereof connected to the first node, and a second electrode thereof connected to the column gate line. When the first node control module includes a second NMOS transistor and the row gate line outputs a high level, the second NMOS transistor is turned on, and the column gate line is connected to the first node. When the row gate line outputs a low level, the second NMOS transistor is turned off, and the column gate line is not connected to the first node.

Specifically, the first node control module may include: a second PMOS transistor, a gate electrode thereof connected to the row gate line, a first electrode thereof connected to the column gate line, and a second electrode thereof connected to the first node. When the first node control module includes a second PMOS transistor and the row gate line outputs a low level, the second PMOS transistor is turned on, and the column gate line is connected to the first node. When the row gate line outputs a high level, the second PMOS transistor is turned off, and the column gate line is not connected to the first node.

Specifically, the storage capacitor module may include: a storage capacitor, the first end thereof connected to the first node, and the second end thereof connected to the high level input end.

The pixel unit circuit of the present disclosure will be described below by way of a specific embodiment.

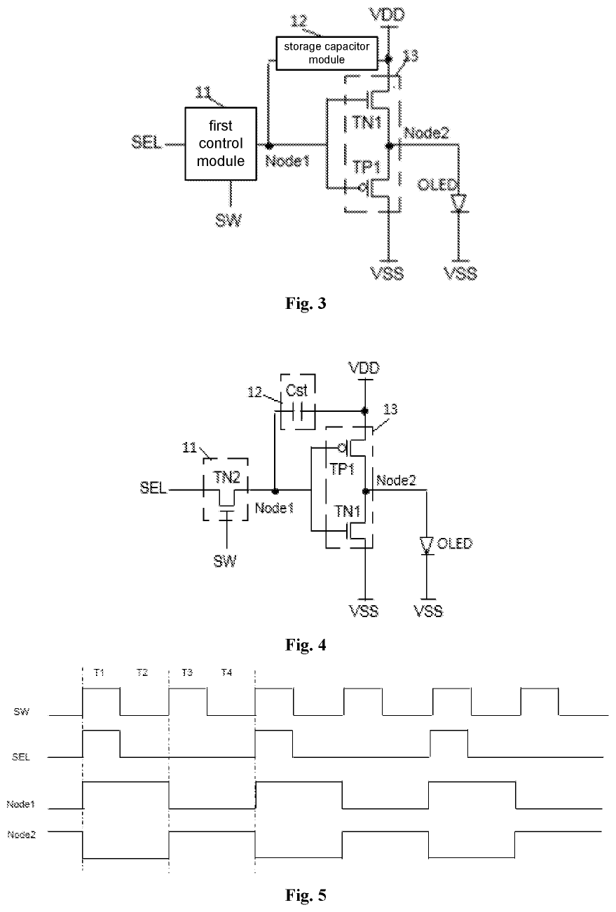

As shown in FIG. 4, a specific embodiment of the pixel unit circuit of the present disclosure includes a first node control module 11, a storage capacitor module 12, a second node control module 13, and an organic light emitting diode OLED.

The second node control module 13 includes: a first PMOS transistor TP1, a gate electrode thereof connected to the first node Node1, a source electrode thereof connected to a high level input end inputting the high level VDD, and a drain electrode thereof connected to the second node Node2; and a first NMOS transistor TN1, a gate electrode thereof connected to the first node Node1, a source electrode thereof connected to a low level input end inputting the low level VSS, and a drain electrode thereof connected to the second node Node2.

The first node control module 11 includes: a second NMOS transistor TN2, a gate electrode thereof connected to the row gate line SW, a source electrode thereof connected to the first node Node1, and a drain electrode thereof connected to the column gate line SEL.

The storage capacitor module 12 includes: a storage capacitor Cst, a first end thereof connected to the first node Node1, and the second end thereof connected to the high-level input end inputting the high level VDD.

The anode of the organic light emitting diode OLED is connected to the second node Node2, and the cathode of the organic light emitting diode OLED is connected to the low level input end inputting the low level VSS.

FIG. 5 is an exemplary timing diagram of a pixel cell circuit as shown in FIG. 4.

In a first time period T1, SW and SEL both output a high level, TN2 is turned on, Node1 reads the high level from SEL, TP1 is turned off, TN1 is turned on, the potential of Node2 is at a low level VSS, and the potential of the anode of the OLED is equal to the potential of the cathode of the OLED, and the OLED does not emit light, that is, the OLED remains in a “dark” state.

In a second time period T2, SW and SEL both output a low level, TN2 is turned off, the potential of Node1 is maintained high by the charge of Cst, TP1 is turned off, TN1 is turned on, and the potential of Node2 is at the low level VSS. The potential of the anode of OLED is equal to the potential of the cathode of the OLED, and the OLED does not emit light, that is, the OLED remains in a “dark” state.

In a third time period T3, SW outputs a high level, SEL outputs a low level, TN2 turns on, Node1 reads the low level from SEL, TP1 turns on, TN1 turns off, the potential of Node2 is at a high level, the voltage difference between the anode of the OLED and the cathodes of the OLED is VDD-VSS, and the OLED emits light, that is, the OLED remains in a “bright” state.

In a fourth time period T4, SW and SEL both output a low level, TN2 is off, the potential of Node1 is maintained low by Cst, TP1 is turned on, TN1 is turned off, the potential of Node2 is at a high level, and the voltage difference between the anode of OLED and the cathode of OLED is VDD-VSS, and the OLED emits light, that is, the OLED remains “bright”.

As can be seen from the above, the specific embodiment of the pixel unit circuit shown in FIG. 4 is in operation mode, the potential of the first node Node1 is controlled by the cooperation of the timing of the row gate signal from the row gate line SW and the timing of the column gate signal from the column gate line SEL. TP1 or TN2 is determined to be turned on based on the potential of the first node Node1, so as to determine that the potential of the second node Node2 is VDD or VSS. When TP1 is turned on, the OLED is in a “bright” state; when TN1 is turned on, the OLED is in a “dark” state. When TP1 and TN1 are in operation, they are all in saturation region or turned off, thus only acts as a switch. The ratio of turning-on time period and turning-off time period of TP1 and TN1 is used to control the brightness of the light. The actual working time for the OLED in one frame is only the time for emitting light. Thus the operating time and average current of the OLED are reduced.

The pixel unit circuit of the embodiment of the present disclosure does not need to control the light emission brightness of the silicon-based OLED (organic light-emitting diode) by driving the current of the MOS transistor in the sub-threshold region, and the transistors in the pixel unit circuit according to the embodiment of the present disclosure only functions as switches, so the size of the transistor can be made small, which is advantageous for achieving high resolution. Furthermore, the average current flowing through the OLED and the brightness of the OLED can be adjusted based on the cooperation of the timing of the row gate signal from the row gate line SW and the timing of the column gate signal from the column gate line SEL.

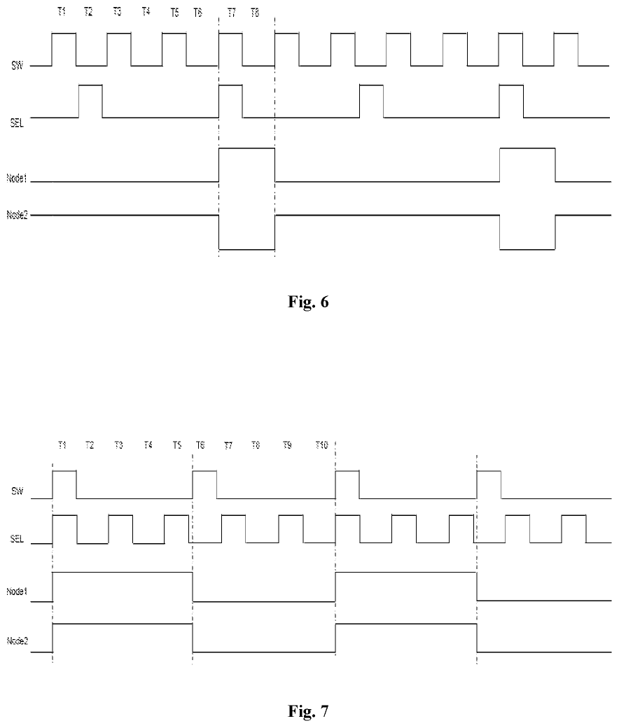

In some embodiments, as shown in FIG. 6, the waveform of the row gate signal from SW can be fixed, and the period of the column gate signal from SEL can be changed, so that the OLED emits different brightness. In FIG. 6, the first time stage is T1, the second time stage is T2, the third time stage is T3, the fourth time stage is T4, the fifth time stage is T5, the sixth time stage is T6, the seventh time stage is T7, and the eighth time stage is T8. When the timing of the row gate signal from SW and the timing of the column gate signal from SEL are as shown in FIG. 6, the OLED is in a “bright” state at T1-T6, and the OLED is in a “dark” state at T7-T8.

In some embodiments, as shown in FIG. 7, the waveform of the row gate signal from SEL can be fixed, and the period of the column gate signal from SW can be changed, so that the OLED emits different brightness. In FIG. 7, the first time stage is T1, the second time stage is T2, the third time stage is T3, the fourth time stage is T4, the fifth time stage is T5, the sixth time stage is T6, the seventh time stage is T7, the eighth time stage is T8, the ninth time stage is T9, and the tenth time stage is T10. When the timing of the row gate signal from SW and the timing of the column gate signal from SEL are as shown in FIG. 7, the OLED is in a “bright” state at T1-T5, and the OLED is in a “dark” state at T6-T10.

In actual operation, the timing of the row gate signal from the row gate line and the timing of the column gate signal from the column gate line may vary according to actual conditions.

A method for driving a pixel unit circuit according to an embodiment of the present disclosure, for driving the above pixel unit circuit, the driving method includes: controlling, the first control module, whether the first node is electrically connected to the column gate line under the control of the row gate line; controlling, the second control module, the first end of the light emitting element to be connected to the high level input end or the low level input end under the control of the first node, so that the light emitting element emits light or does not emit light. Optionally, when the second node control module controls the second node to be connected to the high level input end, the light emitting element emits light; when the second node control module controls the second node to be connected to the low level input end, the light-emitting elements do not emit light.

It should be understood that in some embodiments, the light emitting element emits light when the potential of the second node is at a low level, and the light emitting element does not emit light when the potential of the second node is at a high level. The details are not described herein again.

Specifically, when the first node control module includes the second NMOS transistor, the step of controlling, by the first node control module, whether the first node is connected to the column gate line under the control of the row gate line includes: when the row gate line outputs a high level signal, the second NMOS transistor is turned on, thereby controlling the first node to be connected to the column gate line; and when the row gate line outputs a low level signal, the second NMOS transistor is turned off, thereby controlling the first node not to be connected to the column gate line.

Specifically, when the first node control module includes the second PMOS transistor, the step of controlling, by the first node control module, whether the first node is connected to the column gate line under the control of the row gate line includes: when the row gate line outputs a low level signal, the second PMOS transistor is turned on, thereby controlling the first node to be connected to the column gate line; and when the row gate line outputs a high level signal, the second PMOS transistor is turned off, thereby controlling the first node not to be connected to the column gate line.

Specifically, when the second node control module includes a first PMOS transistor, a gate electrode thereof connected to the first node, a first electrode thereof connected to the high level input end, and a second electrode thereof connected to the second node; and a first NMOS transistor, the gate electrode thereof connected to the first node, the first electrode thereof connected to the low-level input end, and the second electrode thereof is connected to the second node, the step of controlling, by the second node control module, the second node to be connected to the high level input end or the low level input end, includes the following.

When the potential of the first node is at a high level, the first PMOS transistor is turned off and the first NMOS transistor is turned on, to control the second node to be connected to the low level input, so that the potential of the second node is at a low level, and the light emitting element does not emit light.

When the potential of the first node is at a low level, the first PMOS transistor is turned on and the first NMOS transistor is turned off, to control the second node to be connected to the high level input end, so that the potential of the second node is at a high level, and the light emitting element emits light.

Specifically, when the second node control module includes: a first NMOS transistor, a gate electrode thereof connected to the first node, a first electrode thereof connected to the second node, and a second electrode thereof connected to the high level; and a first PMOS transistor, the gate electrode thereof connected to the first node, the first electrode thereof connected to the second node, and the second electrode thereof connected to the low level input, the step of controlling, by the second node control module, the second node to be connected to the high level input end or the low level input end includes the following.

When the potential of the first node is at a low level, the first PMOS transistor is turned on and the first NMOS transistor is turned off, to control the second node to be connected to the low-level input, so that the potential of the second node is at a low level and the light emitting element does not emit light.

When the potential of the first node is at a high level, the first PMOS transistor is turned off and the first NMOS transistor is turned on, to control the second node to be connected to the high-level input end, so that the second The potential of the node is at a high level and the light emitting element emits light.

The pixel circuit of the embodiment of the present disclosure is disposed on a silicon substrate, and includes a plurality of row gate lines, a plurality of column gate lines, and a plurality of pixel unit circuits arranged in an array. The pixel unit circuits located in a same row are connected to a same row gate line. The pixel unit circuits located in a same column are connected to a same column gate line.

The display device according to the embodiment of the present disclosure includes a silicon substrate, a plurality of row gate lines and a plurality of column gate lines disposed on the silicon substrate, and a plurality of pixel unit circuits arranged in an array. The pixel unit circuits located in a same row are connected to a same row gate line. The pixel unit circuits located in a same column are connected to a same column gate line.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A pixel unit circuit, comprising a first control module, a storage capacitor module, a second control module, and a light emitting element, wherein
a first end, a second end, and a third end of the first control module are respectively connected to a row gate line, a column gate line, and a first end of the storage capacitor module and a first end of the second control module, the first control module is configured to control whether the first end of the second control module and the first end of the storage capacitor module are electrically connected to the column gate line under the control of the row gate line;
a second end of the storage capacitor module is connected to a high level input end;
a second end, a third end, and a fourth end of the second control module are respectively connected to a first end of the light emitting element, a high level input end, and a low level input end, the second control module is configured to control the first end of the light emitting element to be electrically connected to the high level input or the low level input end by a potential of the first end of the second control module.

2. The pixel unit circuit according to claim 1, wherein the second control module comprises:
a first PMOS transistor, a gate electrode of the first PMOS transistor connected to a third end of the first control module and a first end of the storage capacitor module, a first electrode of the first PMOS transistor connected to the high level input end, and a second electrode of the first PMOS transistor connected to a first end of the light emitting element; and
a first NMOS transistor, a gate electrode of the first NMOS transistor connected to the third end of the first control module and the first end of the storage capacitor module, a first electrode of the first NMOS transistor connected to the low level input end, and a second electrode of the first NMOS transistor connected to the first end of the light emitting element.

3. The pixel unit circuit according to claim 1, wherein the second control module comprises:
a first NMOS transistor, a gate electrode of the first NMOS transistor connected to a third end of the first control module and a first end of the storage capacitor module, a first electrode of the first NMOS transistor connected to a first end of the light emitting element, and a second electrode of the first NMOS transistor connected to a high level input end; and
a first PMOS transistor, a gate electrode of the first PMOS transistor connected to the third end of the first control module and the first end of the storage capacitor module, a first electrode of the first PMOS transistor connected to the first end of the light emitting element, and a second electrode of the first PMOS transistor connected to the low level input end.

4. The pixel unit circuit according to claim 2, wherein the first control module comprises:
a second NMOS transistor, a gate electrode of the second NMOS transistor connected to the row gate line, a first electrode of the second NMOS transistor connected to the gate electrode of the first PMOS transistor, the gate electrode of the first NMOS transistor, and the first end of the storage capacitor module, and a second electrode of the second NMOS transistor connected to the column gate line.

5. The pixel unit circuit according to claim 2, wherein the first control module comprises:
a second PMOS transistor, a gate electrode of the second PMOS transistor connected to the row gate line, a first electrode of the second PMOS transistor connected to the column gate line, and a second electrode of the second PMOS transistor connected to the gate electrode of the first PMOS transistor, the gate electrode of the first NMOS transistor, and the first end of the storage capacitor module.

6. The pixel unit circuit according to claim 3, wherein the first control module is configured to:
control brightness of the light emitting element based on a ratio of turning-on time period and turning-off time period of the first PMOS transistor within a display frame; or
control brightness of the light emitting element based on a ratio of turning-on time period and turning-off time period of the first NMOS transistor within a display frame.

7. The pixel unit circuit according to claim 1, wherein the storage capacitor module comprises:
a storage capacitor, the first end of the storage capacitor connected to the third end of the first control module and the first end of the second control module, and the second end of the storage capacitor connected to the high level input end.

8. The pixel unit circuit according to claim 1, wherein
the second end of the light emitting element is connected to the low level input end,
the light emitting element comprises an organic light emitting diode,
the first end of the light emitting element is an anode of the organic light emitting diode, and the second end of the light emitting element is a cathode of the organic light emitting diode.

9. The pixel unit circuit according to claim 1, wherein
the second end of the light emitting element is connected to the high level input end,
the light emitting element comprises an organic light emitting diode,
the first end of the light emitting element is a cathode of the organic light emitting diode, and the second end of the light emitting element is an anode of the organic light emitting diode.

10. A method for driving a pixel unit circuit according to claim 1, the method comprises:
controlling, by the first control module, whether the first end of the storage capacitor module and the first end of the second control module being electrically connected to the column gate line under the control of the row gate line;
controlling, by the second control module, the first end of the light emitting element to be connected to the high level input end or the low level input end under the control of a potential of a first end of the second control module, so that the light emitting element emits light or does not emit light.

11. The method according to claim 10, wherein the first control module includes a second NMOS transistor having a gate electrode connected to the row gate line, a first electrode connected to the first end of the second control module and the first end of the storage capacitor module, and a second electrode connected to the column gate line,
the step of controlling, by the first control module, whether the first end of the second control module and the first end of the storage capacitor module are connected to the column gate line under the control of the row gate line includes:
when the row gate line outputs a high level signal, the second NMOS transistor being turned on, thereby controlling the first end of the second control module and the first end of the storage capacitor module to be connected to the column gate line; and
when the row gate line outputs a low level signal, the second NMOS transistor being turned off, thereby controlling the first end of the second control module and the first end of the storage capacitor module not to be connected to the column gate line.

12. The method according to claim 10, wherein the first control module includes a second PMOS transistor having a gate electrode connected to the row gate line, a first electrode connected to the column gate line, and a second electrode connected to the first end of the second control module and the first end of the storage capacitor module,
the step of controlling, by the first control module, whether the first end of the second control module and the first end of the storage capacitor module are connected to the column gate line under the control of the row gate line includes:
when the row gate line outputs a low level signal, the second PMOS transistor being turned on, thereby controlling the first end of the second control module and the first end of the storage capacitor module to be connected to the column gate line; and
when the row gate line outputs a high level signal, the second PMOS transistor being turned off, thereby controlling the first end of the second control module and the first end of the storage capacitor module not to be connected to the column gate line.

13. The method according to claim 10, wherein
when the second control module includes a first PMOS transistor having a gate electrode connected to the third end of the first control module and the first end of the storage capacitor module, a first electrode connected to the high level input end, and a second electrode connected to the first end of the light emitting element; and a first NMOS transistor having a gate electrode connected to the third end of the first control module and the first end of the storage capacitor module, the first electrode connected to the low level input end, and the second electrode connected to the first end of the light emitting element,
the step of controlling, by the second control module, the first end of the light emitting element to be connected to the high level input end or the low level input end under the potential of the first end of the second control module, includes:
when the potential of the first end of the second control module is at a high level, the first PMOS transistor being turned off and the first NMOS transistor being turned on, to control the first end of the light emitting element to be connected to the low level input;
when the potential of the first end of the second control module is at a low level, the first PMOS transistor being turned on and the first NMOS transistor being turned off, to control the first end of the light emitting element to be connected to the high level input end.

14. The method according to claim 10, wherein
the second control module includes a first NMOS transistor having a gate electrode connected to the third end of the first control module and the first end of the storage capacitor module, a first electrode connected to the first end of the light emitting element, and a second electrode connected to the high level input end, and; and a first PMOS transistor having a gate electrode connected to the third end of the first control module and the first end of the storage capacitor module, the first electrode connected to the first end of the light emitting element, and the second electrode connected to the low level input end,
the step of controlling, by the second control module, the first end of the light emitting element to be connected to the high level input end or the low level input end under the potential of the first end of the second control module, includes:
when the potential of the first end of the second control module is at a low level, the first PMOS transistor being turned on and the first NMOS transistor being turned off, to control the first end of the light emitting element to be connected to the low level input;
when the potential of the first end of the second control module is at a high level, the first PMOS transistor being turned off and the first NMOS transistor being turned on, to control the first end of the light emitting element to be connected to the high level input end.

15. The method according to claim 13, further comprising:
controlling, by the first control module, brightness of the light emitting element based on a ratio of turning-on time period and turning-off time period of the first PMOS transistor within a display frame; or
controlling, by the first control module, brightness of the light emitting element based on a ratio of turning-on time period and turning-off time period of the first NMOS transistor within a display frame.

16. The method according to claim 10, wherein
the second end of the light emitting element is connected to the low level input end,
the light emitting element comprises an organic light emitting diode, the first end of the light emitting element is an anode of the organic light emitting diode, and the second end of the light emitting element is a cathode of the organic light emitting diode,
when the first end of the light emitting element is connected to the low level input end, the light emitting element does not emit light, and when the first end of the light emitting element is connected to the high level input end, the light emitting element emits light.

17. The method according to claim 10, wherein
the second end of the light emitting element is connected to the high level input end,
the light emitting element comprises an organic light emitting diode, the first end of the light emitting element is a cathode of the organic light emitting diode, and the second end of the light emitting element is an anode of the organic light emitting diode,
when the first end of the light emitting element is connected to the low level input end, the light emitting element emits light, and when the first end of the light emitting element is connected to the high level input end, the light emitting element does not emit light.

18. A pixel circuit disposed on a silicon substrate, comprising:
a plurality of row gate lines,
a plurality of column gate lines, and
a plurality of pixel unit circuits according to claim 1 arranged in an array, wherein
the pixel unit circuits located in a same row are connected to a same row gate line;
the pixel unit circuits located in a same column are connected to a same column gate line.

19. A display device, comprising:
a silicon substrate, and
a plurality of row gate lines and a plurality of column gate lines disposed on the silicon substrate, and
a plurality of pixel unit circuits according to claim 1 arranged in an array;
wherein the pixel unit circuits located in a same row are connected to a same row gate line;
wherein the pixel unit circuits located in a same column are connected to a same column gate line.
